(19) United States
(12) Patent Application Publication
(10) Pub. No.: US 2020/0088453 A1
(43) Pub. Date: Mar. 19, 2020

(54) PULSED LIQUID-GAS ENTRAINED CRYOGEN FLOW GENERATOR

(71) Applicant: Michael D. Newman, Hillsborough, NJ (US)

(72) Inventor: Michael D. Newman, Hillsborough, NJ (US)

(21) Appl. No.: 16/689,524

(22) Filed: Nov. 20, 2019

Related U.S. Application Data
(63) Continuation of application No. 14/816,096, filed on Aug. 3, 2015.

(51) Int. Cl. F25D 3/10; F25D 3/11; A23L 3/375

(52) U.S. Cl. CPC F25D 3/10; A23L 3/375; F25D 3/11

(57) ABSTRACT

An apparatus for providing a liquid-gas entrained cryogen mixture onto a food product includes a first pipe through which is provided a flow of liquid cryogen; a second pipe through which is provided a flow of gaseous cryogen, the second pipe in fluid communication with the first pipe at a mixing region; and a pulsing valve disposed at an interior of the second pipe upstream of the mixing region, the pulsing valve adapted for releasing the gaseous cryogen into the liquid cryogen at select intervals of time to provide a pulsating flow of the liquid-gas entrained cryogen mixture downstream of the mixing region for contacting the food product. A related method is also provided.

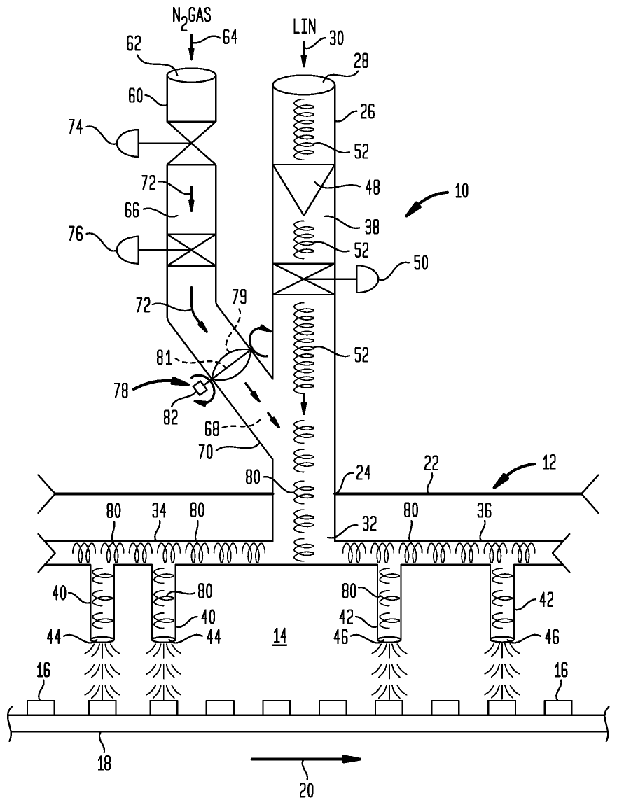

### RELATED APPLICATIONS

This application claims the benefit of U.S. Non-Provisional application Ser. No. 14/816,096, filed on Aug. 3, 2015, which is incorporated herein by reference.

### BACKGROUND OF THE INVENTION

The present embodiments relate to food freezer tunnel apparatus for cryogenically chilling for example food products, and related processes therefore.

Food freezing tunnels, such as for example those that use cryogenic substances to chill and/or freeze food products, are limited in their capacity by the overall heat transfer co-efficient that they can use on the products. For example, many food freezing tunnels rely upon increasing heat transfer effect by correspondingly increasing air flow velocity across the product for which the heat transfer is to be applied. There are, unfortunately, practical and economic limitations in many of these apparatus and methods and therefore, the increased heat transfer effect is not fully realized, especially with large scale industrial operations. The food processing industry would benefit from increased heat transfer effect with food freezing applications, because greater heat transfer effect results in being able to use smaller apparatus or conversely, using apparatus which can increase the production or flow through rate of products to be chilled or frozen.

Some improvements have found their way into food freezing tunnels. For example spray nozzles are now used to increase the overall heat transfer effecting during the freezing process by spraying liquid nitrogen (N₂) through the nozzles directly onto the surface of the food product to contact same with droplets of the cryogenic substance. These small nitrogen droplets contact the warm food product and evaporate quickly, thereby removing or transferring heat immediately from the surface of the food product to chill and further freeze same.

Other apparatus and systems use high pressure liquid nitrogen to provide heat transfer at the surface of the food product. However, this is an expensive process and can result in an unusually large amount of the nitrogen product which must therefore be lost to waste or alternatively additional equipment provided to recycle the nitrogen. In both instances, increased costs and a larger footprint of the food freezing tunnel is necessary, thereby making this type of application less desirable.

### SUMMARY OF THE INVENTION

There is provided herein a pulsed heat transfer effect apparatus and method for products, such as for example food products, wherein a high pressure nitrogen gas is pulsed into a liquid nitrogen flow stream, which stream thereafter is sprayed from nozzles thereby increasing turbulence on a surface of a food product to facilitate and promote increased heat transfer effect at the food product. The combination of the nitrogen gas, liquid nitrogen, and pulsing of same, results in extremely small nitrogen droplets which evaporate more quickly and therefore result in a higher evaporative surface cooling (heat transfer effect) at the surface of the food product. In addition, the pulsed spray results in increasing turbulence of the cryogenic substance on the surface of the product which accordingly promotes increased heat transfer, i.e. heat removal from the product. Carbon dioxide may be used instead of nitrogen.

There is therefore provided an apparatus embodiment for providing a liquid-gas entrained cryogen mixture onto a food product which includes a first pipe through which is provided a flow of liquid cryogen; a second pipe through which is provided a flow of gaseous cryogen, the second pipe in fluid communication with the first pipe at a mixing region; and a pulsing valve disposed at an interior of the second pipe upstream of the mixing region, the pulsing valve adapted for releasing the gaseous cryogen into the liquid cryogen at select intervals of time to provide a pulsating flow of the liquid-gas entrained cryogen mixture downstream of the mixing region for contacting the food product.

Another apparatus embodiment calls for the pulsing valve including an axle spanning an internal diameter of the second pipe and rotatably mounted therein; a planar member mounted to the axle and having a surface area substantially similar to a cross-sectional diameter of the second pipe; and a motor operatively connected to the axle for rotation of said axle and the planar member mounted thereto.

Various valves and backflow preventers are used to control and restrict flow of the cryogen liquid and gas.

There is also provided a method embodiment of providing a flow of a liquid-gas entrained cryogen mixture onto a food product which includes providing a first flow of liquid cryogen to the food product; providing a second flow of a gaseous cryogen to contact the first flow at a mixing region of the first and second flows; and repetitively interrupting the second flow upstream of the mixing region to provide a pulsating flow of the gaseous cryogen into the liquid cryogen for providing a pulsating flow of a liquid-gas entrained cryogen mixture to the food product.

The liquid and gaseous cryogen may be selected from nitrogen (N₂) and carbon dioxide (CO₂).

Other features of the present embodiments are described hereinafter.

### BRIEF DESCRIPTION OF THE DRAWING

For a more complete understanding of the present invention, reference may be had to the following description of exemplary embodiments considered in connection with the accompanying drawing FIGURE, which FIGURE shows a pulsed liquid-gas entrained cryogen flow generator apparatus to be used with for example food products.

### DETAILED DESCRIPTION OF THE INVENTION

Before explaining the inventive embodiments in detail, it is to be understood that the invention is not limited in its application to the details of construction and arrangement of parts illustrated in the accompanying drawings, if any, since the invention is capable of other embodiments and being practiced or carried out in various ways. Also, it is to be understood that the phraseology or terminology employed herein is for the purpose of description and not of limitation.

Referring to the FIGURE, an apparatus is shown generally at 10 for pulsing liquid nitrogen droplets from nozzles onto a food product or products being conveyed for providing increased heat transfer effect at the food product to chill and/or freeze same. In certain applications, carbon dioxide (CO₂) can be used instead of nitrogen (N₂). By way of example only, nitrogen (in liquid and gaseous phase) will be referred to herein when describing the present embodiments.

The present embodiments provide for the mixing of gaseous nitrogen and liquid nitrogen to produce an arrangement of pulsing spray jets of the nitrogen to provide a high heat transfer effect at food products being conveyed or transported in close proximity to the spray nozzles. The gaseous nitrogen may be provided at 200 psig, while the liquid nitrogen (LIN) can be provided at 30 psig.

For purposes herein, the nitrogen droplets emitted from the nozzles have a diameter of approximately 20 to 100 μm.

Referring to the FIGURE, the apparatus 10 of the present embodiments and related method embodiments can be used in conjunction with or retrofitted to a food freezing tunnel such as that shown generally at 12. The tunnel 12 has an interior space 14 or chamber for chilling and freezing, and through which product 16, such as for example food products, are transported on a conveyor belt 18. The conveyor belt 18 transits the space 14 in a direction represented by arrow 20, by way of example only. The tunnel 12 is also provided with an inlet (not shown) and an outlet (not shown) in communication with the space 14 for introducing the food product 16 on the conveyor belt 18 through the space. The food freezing tunnel 12 can be disposed for operation in many different types of food processing plants and facilities. The tunnel 12 includes a housing having a sidewall 22 which defines the space 14. At a region of the sidewall 22, usually at an upper area of the sidewall, there is provided an aperture 24 or port therein.

Referring more specifically to the apparatus 10 of the present embodiments, said apparatus includes a pipe 26 having an upper end with an opening 28 into which can be introduced by gravity or otherwise liquid nitrogen (LIN) 30. The pipe 26 extends through the aperture 24 in the sidewall 22 of the freezing tunnel 12 and terminates in another opening 32 in the space 14. At the opening 32 of the pipe 26, said opening splits into a “T” for branches 34,36 which are in fluid communication with an internal space 38 of the pipe 26. Each one of the branches 34,36 has at least one corresponding nozzle 40 or nozzle 42, respectively. The nozzles 40,42 are also disposed in the space 14, each nozzle having a respective opening 44,46 in close proximity to the conveyor belt 18 and food product 16 being transported thereon.

The LIN pipe 26 has disposed within the internal space 38 a back flow preventer 48 and, further downstream in the pipe 26, a control valve 50. Accordingly, the LIN 30 introduced through the opening 28 into the pipe 26 travels through the internal space 38 where its flow rate is controlled by the control valve 50, while the backflow preventer 48 prevents the LIN, regardless of pressure in the internal space or the chamber 14, from being exhausted or regurgitated upstream and back through the opening 28 and into the plant or other processing facility.

The LIN flow 30 being introduced into the pipe 26 flows continuously through the internal space 38 as indicated generally at 52, until such time as the LIN flow comes in contact with gaseous nitrogen, as will be explained below.

The apparatus 10 includes another pipe 60 having an opening 62 into which gaseous nitrogen 64 can be introduced into an internal space 66 of the pipe. The pipe 60 extends to have another opening 68. The pipe 60 is constructed to join in fluid communication with the internal space 38 of the pipe 26. The region where the opening 68 of the pipe 60 is in fluid communication with the internal space 38 of the pipe 26 is shown generally at 70. A flow of the gaseous nitrogen is shown generally by arrows 72.

Disposed in the internal space 66 of the pipeline 60 is a modulating valve 74 and an on/off valve 76. As is shown in the FIGURE, the modulating valve 74 is disposed upstream of the on/off valve 76 in the internal space 66.

Downstream in the internal space 66 from the on/off valve 76 and upstream of the opening 68 there is disposed a pulsing valve 78. The pulsing valve 78 is disposed slightly upstream from the opening 68 and the region 70, just before the gaseous nitrogen 64 is introduced into the LIN flow 52 travelling through the pipe 26. The pulsing valve 78 includes a planar member 79, such as for example a circular disc, mounted to an axle 81 or spindle which is connected to a motor 82 or other power source to rotate the axle. The disc has a diameter slightly less than a diameter of the internal space 66, and a circumference slightly less than a cross-sectional circumference of the internal space 66 so that the disc can freely rotate therein. The pulsing valve 78 operates by rotating the flat circular disk in the pipe 60 at a selected speed to provide the pulse rate of gas flow 72 into the LIN flow stream 52. That is, a higher rotational speed of the disk will result in a higher pulse rate, while a lower rotational speed of the disk will result in a lower pulse rate.

The modulating valve 74 is used to control the flow of the gaseous nitrogen 64, while the on/off valve 76 is used to shut off the flow completely or allow same to pass.

The region 70 where the pipelines 26 and 60 are in fluid communication is shown as a “Y” junction for the gaseous nitrogen to be “pulsed” into the LIN flow 52. The region 70 could alternatively be constructed as a “T” junction.

The operation of the apparatus 10 will now be described. The LIN control valve 50 is opened to permit liquid nitrogen to begin flowing along the internal space 38 of the pipe 26 in a direction to the food freezing tunnel 12. The LIN flow 52 flows into the spray manifold which consists of the branches 34,36 in fluid communication with the pipe 26 and thereafter through the nozzles 40,42, whereupon the LIN is deposited onto the food product 16 being transported on the conveyor belt 18 through the space 14.

After the LIN flow 52 is established, a pulsed atomized flow of gaseous nitrogen is produced by actuating the pulsing valve 78, after which the modulating valve 74 and the on/off valve 76 are also opened. High pressure gaseous nitrogen 64 at a pressure higher than the LIN flow 52 travels down the pipeline 60 and into the LIN flow 52. The pulsing valve 78 opens and closes at a fixed or variable rate. When the pulsing valve 78 is closed, a minimal gas flow into the LIN flow 52 occurs. However, when the pulsing valve 78 is opened, the gaseous nitrogen 64 flows into and contacts the LIN flow 52 at the region 70. The rate of rotation of pulsing valve 78 determines the frequency of liquid/gas pulsing 80 to be sent from the nozzle openings 44, 46 to the underlying food product 16. The pulsing valve 78 is a butterfly valve which is constructed for this application to attain high speed, continuous rotation. An actuator or motor for the valve 78 can be speed controlled, and also stopped for the valve to be in either open or closed positions with respect to the internal space 66.

The apparatus 10 also provides for maintaining the pulsing valve 78 in an open or closed position or “unbalanced durations” in order to vary a degree of liquid or gas pulse composition to be used for the particular application. It is also possible to use the modulating valve 74 and control valve 50 to control the gas-liquid mixture ratio to occur at the region 70. This ratio can determine the degree of atomization and the resulting nitrogen droplet size to be present in the liquid gas pulses 80 emitted from the nozzle openings 44, 46. This arrangement permits the apparatus 10 to, in effect, provide a pocket of gas followed by a pocket of liquid repetitively and continuously as necessary for the liquid-gas pulses 80 to flow from the region 70 through the nozzles 40, 42 and the nozzle openings 44,46.

When liquid and gaseous nitrogen are used, the gaseous nitrogen 64 must always be at a higher pressure than the LIN 30 to prevent a backflow of the LIN into the internal space 66 of the pipe 60.

In those applications where carbon dioxide is used, both liquid and gaseous carbon dioxide must be maintained at a pressure exceeding 100 psig so that the liquid CO₂ can be delivered in the apparatus. However, the gaseous CO₂ delivered to the pipe 60 must always be at a pressure above a pressure of the liquid CO₂ delivered through the pipe 26 to similarly prevent a backflow of the liquid CO₂ from entering into the internal space 66 of the pipe 60.

The pipes 26,60 can be manufactured from stainless steel, copper, aluminum or any other material suitable for being exposed to fluids at a cryogenic temperature.

The apparatus 10 and related method of the present embodiments increases overall heat transfer effect to cryogenic tunnel freezers and therefore, increases the overall efficiency of freezing applications.

It will be understood that the embodiments described herein are merely exemplary, and that one skilled in the art may make variations and modifications without departing from the spirit and scope of the invention. All such variations and modifications are intended to be included within the scope of the invention as described and claimed herein. Further, all embodiments disclosed are not necessarily in the alternative, as various embodiments of the invention may be combined to provide the desired result.

What is claimed is:

1. An apparatus for providing a liquid-gas entrained cryogen mixture onto a food product, comprising:
a first pipe through which is provided a flow of liquid cryogen;
a second pipe through which is provided a flow of gaseous cryogen, the second pipe in fluid communication with the first pipe at a mixing region; and
a pulsing valve disposed at an interior of the second pipe upstream of the mixing region, the pulsing valve adapted for releasing the gaseous cryogen into the liquid cryogen at select intervals of time to provide a pulsating flow of the liquid-gas entrained cryogen mixture downstream of the mixing region for contacting the food product.

2. The apparatus of claim 1, wherein the pulsing valve is constructed and arranged within the second pipe for rotational movement therein.

3. The apparatus of claim 2, wherein the pulsing valve comprises:
an axle spanning an internal diameter of the second pipe and rotatably mounted therein;
a planar member mounted to the axle and having a surface area substantially similar to a cross-sectional diameter of the second pipe; and
a motor operatively connected to the axle for rotation of said axle and the planar member mounted thereto.

4. The apparatus of claim 3, wherein the planar member comprises a circular disc.

5. The apparatus of claim 1, further comprising an on/off valve disposed within the second pipe upstream of the pulsing valve.

6. The apparatus of claim 5, further comprising a modulating valve disposed within the second pipe upstream of the on/off valve.

7. The apparatus of claim 1, further comprising a modulating valve disposed within the second pipe upstream of the pulsing valve.

8. The apparatus of claim 1, further comprising a control valve disposed within the first pipe upstream of the mixing region.

9. The apparatus of claim 8, further comprising a back flow preventer disposed within the first pipe upstream of the control valve.

10. The apparatus of claim 1, further comprising a back flow preventer disposed within the first pipe upstream of the mixing region.

11. The apparatus of claim 8, further comprising a spray bar in fluid communication with the first pipe and disposed in a space at which the food product is present.

12. The apparatus of claim 11, wherein the spray bar comprises at least one opening through which the pulsating flow of the liquid-gas entrained cryogen mixture flows for contacting the food product.

13. The apparatus of claim 12, wherein the spray bar further comprises a nozzle mounted in the at least one opening.

14. The apparatus of claim 11, wherein the spray bar comprises a plurality of sections in fluid communication with the first pipe, each one of the plurality of sections including a plurality of openings through which the pulsating flow of the liquid-gas entrained cryogen mixture flows to contact the food product.

15. The apparatus of claim 1, wherein the liquid cryogen comprises a liquid selected from the group consisting of liquid nitrogen (LIN) and liquid carbon dioxide, and the gaseous cryogen comprises a gas selected from the group consisting of nitrogen (N₂) and carbon dioxide (CO₂).

16. A method of providing a flow of a liquid-gas entrained cryogen mixture onto a food product, comprising:
providing a first flow of liquid cryogen to the food product;
providing a second flow of a gaseous cryogen for contacting the first flow at a mixing region of the first and second flows; and
repetitively interrupting the second flow upstream of the mixing region to provide a pulsating flow of the gaseous cryogen into the liquid cryogen for providing a pulsating flow of a liquid-gas entrained cryogen mixture to the food product.

17. The method of claim 16, further comprising directing the pulsating flow to a spray bar for distributing said pulsating flow to the food product.

18. The method of claim 17, wherein the distributing comprises a plurality of pulsating flows from the spray bar.

19. The method of claim 16, further comprising preventing the first flow from reversing direction away from the mixing region.

20. The method of claim 16, further comprising controlling an amount of each of the first and second flows to the mixing region.

21. The method of claim 16, further comprising separating the pulsating flow of the liquid-gas entrained cryogen mixture into a plurality of discrete flows to the food product.

22. The method of claim 16, wherein the providing the first flow is a 30 psig, and the providing the second flow is at 200 psig.

23. The method of claim 16, wherein the liquid cryogen comprises a liquid selected from the group consisting of LIN and liquid CO₂, and the gaseous cryogen comprises a gas selected from the group consisting of N₂ and CO₂.
